(19) United States
(12) Patent Application Publication
(10) Pub. No.: US 2008/0236332 A1
(43) Pub. Date: Oct. 2, 2008

(54) Reciprocating to rotary mechanical conversion device

(76) Inventors: Karl V. Hoose, Kennebunk, ME (US); Joshua C. Walls, Lyman, ME (US); Ryan Gauthier, Sanford, ME (US)

Correspondence Address: BOHAN MATHERS, PO BOX 17707, PORTLAND, ME, 04112-8707, US

(21) Appl. No.: 11/731,475

(22) Filed: Mar. 30, 2007

(51) Int. Cl. F16H 3/00; F16H 1/14

(52) U.S. Cl. 74/810.1; 74/417

(57) ABSTRACT

A mechanical conversion system for receiving input from a toroidal engine that outputs an oscillating motion. The system has a gear set with facing bevel gears that mesh with radially mounted pinions. The bevel gears are mounted on a splined input shaft via bearings and one-way clutches. An overrunning clutch is coupled with each bevel gear. As the input shaft rotates in one direction, the overrunning clutch of one bevel gear is engaged and drives the one gear in the first direction, while the overrunning clutch of the second bevel gear is disengaged and allows the second bevel gear to overrun the input shaft. The overrunning clutch is a type known as a MECHANICAL DIODE®, which engages within 4.5 degrees of rotation, without significant slippage.

### BACKGROUND INFORMATION

1. Field of the Invention

The invention relates to the field of mechanical drive systems. More particularly, the invention relates to a gear train that converts motion from a reciprocating input shaft to a rotary output shaft.

2. Description of the Prior Art

The inventor of the present invention is also the inventor of a toroidal internal combustion engine, disclosed in U.S. Pat. No. 6,880,494 B2 ('494 patent), issued on Apr. 19, 2005, and which is incorporated herein in its entirety. The toroidal engine of the '494 patent does not have a traditional crank shaft and connecting rods, with pistons that travel linearly in a dedicated chamber. Rather, the pistons oscillate back and forth in a circular chamber, with adjacent pistons moving through a shared chamber. The power output shaft from this toroidal engine, thus, has a counter-rotating oscillatory motion.

Friction clutches are typically used to convert motion from a rotating engine output shaft to another form of power output or drive system. Such clutches have a certain amount of slip between clutch and the rotating power shaft, before the clutch is fully engaged and powering the drive mechanism. This slippage is desirable, to some extent, in conventional drive systems, in order to reduce the impact force applied to the drive system when the two parts, clutch and drive mechanism, engage. Also, because the friction clutch holds with a friction force, designing for high torque applications can cause the friction clutch to be very large and heavy due to material stresses. An immediate positive engagement (no slippage) of the clutch would exert an intolerably large impact on the conventional power or drive systems, resulting in destruction of the system within a short time. Because of this slippage, though, friction clutches take longer to lockup or engage fully, and this makes them distinctly unsuited for use with the counter-rotating oscillatory output of the toroidal internal combustion engine mentioned above.

Energy losses are also associated with the friction heating that occurs during lockup of the friction clutch. These losses can be unacceptably high, if the clutch is called upon to engage and disengage thousands of times a minute, and this is a further disadvantage.

What is needed is a mechanical conversion device that is capable of receiving an oscillating power input and providing a power output that has continuous, non-oscillating rotary motion.

### BRIEF SUMMARY OF THE INVENTION

The invention is a mechanical conversion device (MCD) that converts reciprocating or oscillating motion of an input shaft to continuous rotational motion of an output shaft. The MCD is particularly suited to convert the oscillating motion of the output from the toroidal internal combustion engine of the type disclosed in the '494 patent. The counter-rotating oscillatory motion from the engine is rectified to a constant rotary motion, which is then able to be interfaced with traditional power systems and drive trains.

The MCD of the present application comprises a set of gears for transmitting the counter-rotating periodic power input from the engine and a set of one-way clutches for alternatively engaging the gears for rectification. The gear set includes four gears: two bevel gears mounted via a bearing on a counter-rotating input shaft, the gears facing each other. These two bevel gears mesh with two radially arranged pinions. A one-way clutch is coupled to each bevel gear for the purpose of transmitting motion from the input shaft to the gear. The output of each clutch, thus, drives one bevel gear. As the counter-rotating input shaft oscillates, a first one-way clutch engages the shaft on the clockwise stroke, driving its corresponding first bevel gear, during which time the second one-way clutch is disengaged or overrunning, thus allowing its corresponding second bevel gear to overrun the shaft input. At this instant, all gears are in rotary motion. As the input shaft starts to slow down to change directions, when the angular velocity of the input shaft decreases below that of the first bevel gear, the first one-way clutch disengages and freewheels. The gears continue to rotate as the input shaft changes direction and catches up to the angular velocity of the second bevel gear, and then the second one-way clutch engages with the second bevel gear and continues driving the system. A first 1:1 output shaft is coupled with one of the bevel gears and, if desired, a second output shaft coupled may be with one or both of the pinions. As a result, the two bevel gears are always driven in opposite directions, but the output shafts rotate continuously in one direction.

Up until now, it has been impossible to operate such a gear train for an engine, because conventional clutches could not operate at the speeds required to convert the counter-rotating oscillatory motion to a smooth continuously rotating motion. Even if conventional clutches could be used, the extremely high number of cycles of engaging-disengaging would result in imminent failure because of excessive wear on the clutches. A break-through was achieved by using a one-way non-slip clutch that is capable of rapidly switching between engaged and overrun mode, essentially without slippage and resulting loss of power. One-way clutches overrun or free-wheel in one direction and lockup in another. The one-way clutches used with the MCD are constructed to lock up within a very small rotation angle that translates into an extremely short period of time. With a very small rotation angle for lock up, the impact of the engagement process is minimized by having the input shaft and output shaft engage at very close to the same angular velocities.

One clutch that is capable of accepting the forces and engaging/disengaging at the necessary speeds is a commercially available one-way drive device or overrunning clutch, such as the MECHANICAL DIODE ® from Epilogics, L.P. of Los Gatos, Calif., described in U.S. Pat. No. 5,070,978 that issued Dec. 10, 1991. This overrunning clutch (ORC) is a high-resolution, about 4.5 degrees rotation angle for lock-up, clutch with a very low backlash from overrun to full lock-up. The ORC from Epilogics has a rated torque capacity of 1500 ft-lb, with a maximum overrun speed of 12,000 RPM.

The MCD according to the invention may include up to multiple constant rotary-motion outputs. For example, using the gear set described above, one output is connected to one of the bevel gears and one each connected to the two pinions. In one embodiment of the gear set, for example, the bevel gears are 40-tooth bevel gears, and the pinions 20-tooth bevel gears. The output shaft coupled to a pinion is then driven at a 2:1 ratio and the output shaft coupled to a bevel driven at a 1:1 ratio. It is understood, that the tooth ratios are selected according to the desired output ratios. It is possible to add additional pinions to the basic gear set of two bevel gears and two pinions, if additional outputs and/or ratios are desired. Thus, for example, additional pinions having a different tooth ratio than the two pinions in the basic gear set may be added to the basic gear set, to provide additional outputs that rotate at different speeds.

The MCD according to the invention is uniquely well suited to convert an oscillating motion to a continuous rotary motion. It is also possible, however, to use the MCD together with a rotary input. In this configuration, the output is also a continuous rotary motion. The MCD can be used as a gear-reducer, for example, with the two 2:1 output shafts connected to the pinions rotating continuously in opposite directions to each other. One of the one-way clutches engages initially and stays engaged, with the other one operating in overrun mode. If the 1:1 output shaft is coupled to the gear set, it will be continuously rotating in the direction of its attached bevel gear.

### BRIEF DESCRIPTION OF THE DRAWINGS

The present invention is described with reference to the accompanying drawings. In the drawings, like reference numbers indicate identical or functionally similar elements. The drawings are not necessarily drawn to scale.

FIG. 1 illustrates an assembled gear train assembly according to the invention.

FIG. 2 is a cross-sectional view of the gear train assembly of FIG. 1.

FIG. 3 is a front elevational view of the gear train assembly of FIG. 1.

FIG. 4 is a side elevational view of the gear train assembly of FIG. 1.

FIG. 5 is an exploded view of the gear train assembly of FIG. 1.

FIG. 6A is an exploded view of the bearing assembly for the pinion.

FIG. 6B is a perspective view of the bearing assembly for the pinion.

FIG. 7A is front view of the overrunning clutch. (Prior Art)

FIG. 7B is a cross-sectional view of the overrunning clutch in overrunning mode of operation. (Prior Art)

FIG. 7C is a cross-sectional view of the overrunning clutch in engaged mode of operation. (Prior Art)

FIG. 7D is an illustration of the overrunning clutch mounted on the splined input shaft.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

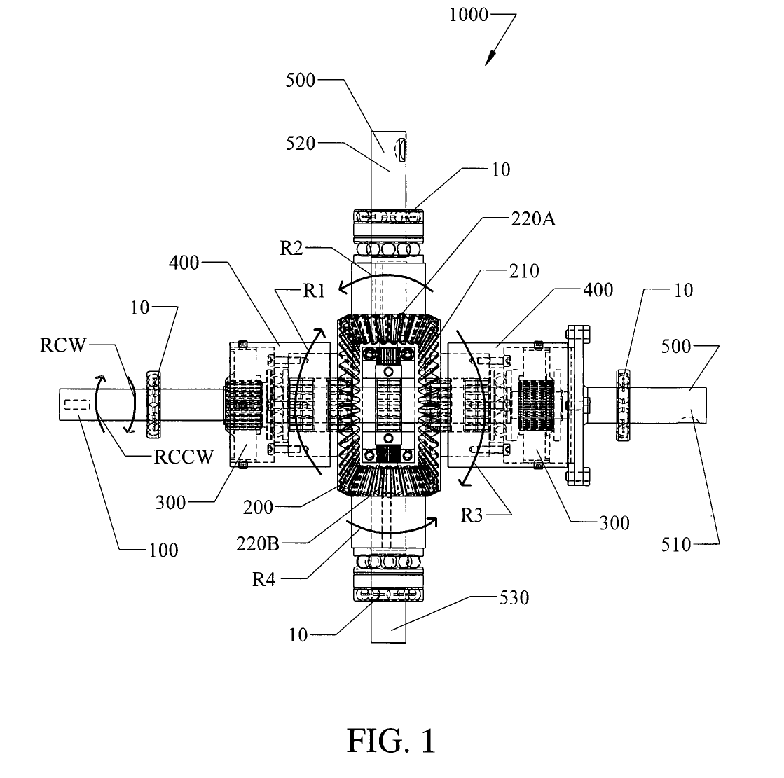

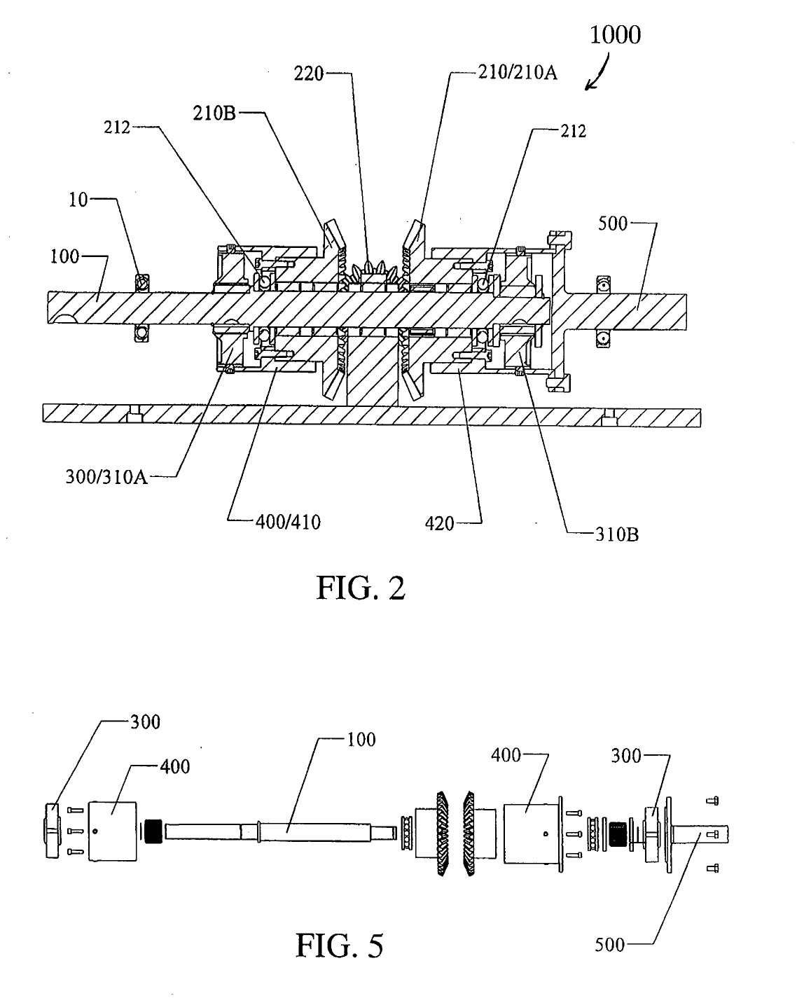

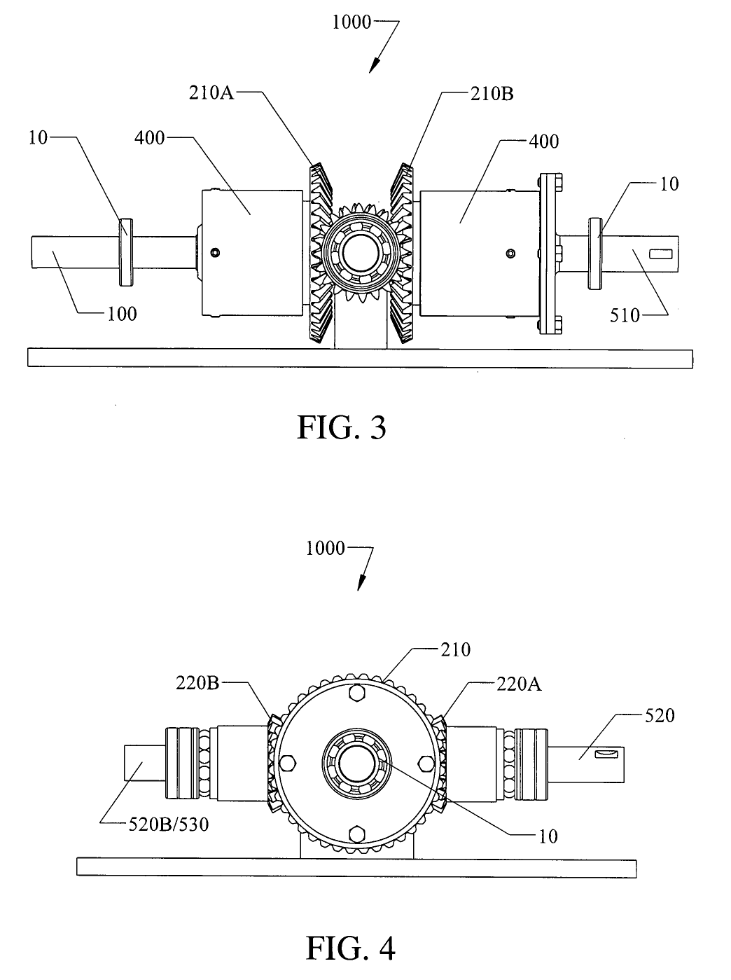

FIGS. 1-5 illustrate a mechanical conversion device (MCD) 1000 according to the invention. The MCD 1000 comprises an input shaft 100, a set of gears 200, at least one pair of one-way or overrunning clutches 300, a pair of couplers 400, individually designated as 410 and 420, and an output shaft 500. The input shaft 100 is connected at a far end (not shown) to a toroidal reciprocating engine and transmits a counter-rotating oscillatory motion into the gear train assembly. The counter-rotating motion is indicated by the two directional arrows Rcw for clockwise motion and Rccw for counter-clockwise motion. The gear set 200 comprises two bevel gears 210 and two pinions 220. The pair of bevel gears 210 is mounted via bearings 212 on the input shaft 100 opposite one another, with the pair of pinions 220 meshed between them in a radial arrangement. The pinions are mounted on pinion bearings 522, shown in FIG. 4. Thus, a first bevel gear 210A and a second bevel gear 210B each mesh with a first pinion 220A and a second pinion 220B, as shown in FIG. 1. In the embodiment shown, the gear ratio of the bevel gear 210 to the pinion 220 is 2:1. Bearing mounts for gears are well known in the art and are therefore not shown in any detail, beyond what is shown in FIGS. 3-5.

Mounted on the input shaft 100 behind each bevel gear 210 is a one-way clutch 300, referred to hereinafter as an overrunning clutch (ORC), and a coupler 400 that couples the ORC 300 to the bevel gear 210. The ORC 300 is a one-way drive device of the type conventionally known as a MECHANICAL DIODE® from Epilogics. It permits engagement in one direction and freewheels in the opposite direction. Rotational arrows R1-R4 indicate the direction of rotation of the bevel gears 210A, 210B and the pinions 220A, 220B. When the input shaft 100 rotates in the clockwise direction, indicated by directional arrow Rcw, a first ORC 310A is engaged attaching the shaft 100 and first bevel gear 220A, and the second ORC 310B is disengaged. The input shaft drives the first bevel gear 210A in the direction indicated by arrow R1. The first pinion 220A rotates in direction R2. The second ORC 310B is disengaged, so the second bevel gear 210B, operating in overrunning mode, is driven by the pinions 220A and 220B to rotate in the direction indicated by R3. When the angular velocity of the input shaft 100 goes below that of the first bevel gear 210A during the direction change, the first ORC 310A disengages from the input shaft, thereby permitting the first bevel gear 210A to overrun the input shaft 100. When the input shaft 100 changes to Rccw and catches up to the angular velocity of the gear set, the second ORC 310B engages and drives the second bevel gear 210B in the direction indicated by arrow R3. In this manner, the pair of bevel gears 210A and 210B are alternately driven by each other, via the input shaft 100 and pinions 220, in opposite rotational directions; yet, even with the counter-rotating oscillatory motion of the power input from the engine, the output shaft 500 of the MCD 1000 according to the invention will be driven in constant rotary motion in one direction. In the embodiment shown, the output shaft 500 includes a primary output shaft 510 that is coupled with the second bevel gear 210B and two secondary output shafts 520, designated individually as 520A, 520B, that are coupled to the pinions 220A or 220B. In this arrangement the primary output shaft 510 is a 1:1 output shaft and the two secondary output shafts 520 are 2:1 output shafts. The secondary output shafts 520 are rotating in opposite directions. The 2:1 gear ratio is mentioned for illustration purposes only. It is understood that the ratio of bevel gear to pinion may be any ratio suitable for the intended purpose of the output shafts 520. Furthermore, rather than having two secondary output shafts, one or both of the shafts connected to the pinions 220 may be a stub axle 530 that is mounted on a support.

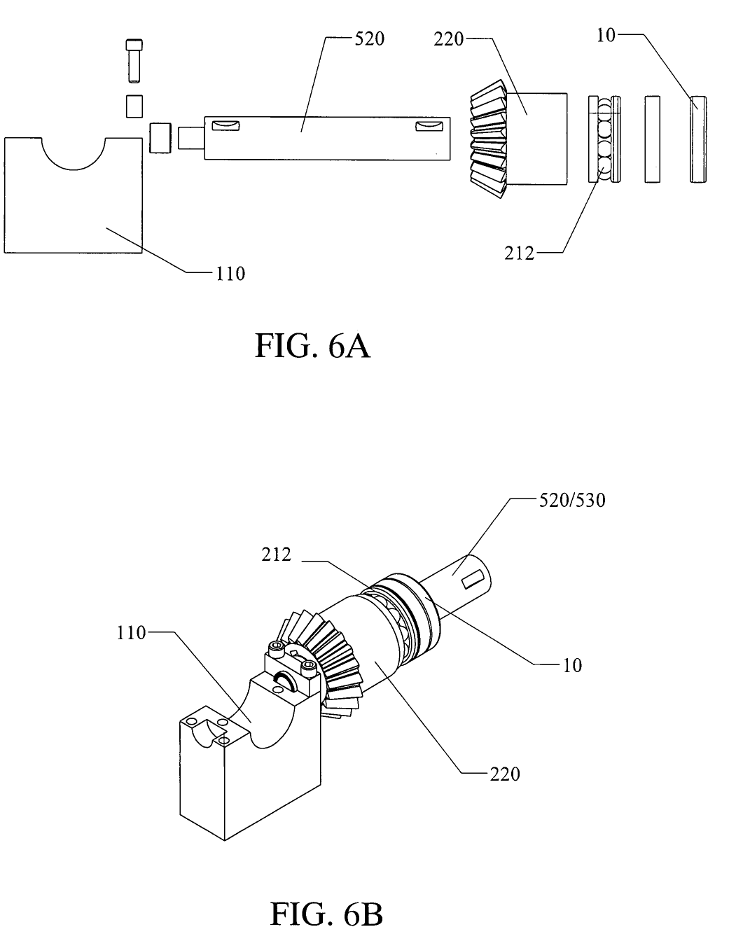

FIGS.6A-6B illustrate a support means for the pinion 220 and the secondary output shaft 520. The secondary output shaft 520 is mounted in a bearing mount 110, which has a recess for supporting the input shaft 100. An end of the secondary output shaft 520 is mounted in the bearing mount 110 as shown in FIG. 6B. The mechanics of supporting shafts and gears are well known in the art, and these figures are only illustrative of suitable means and method of mounting the pinion gears 220 and the output shafts 520, but are not meant to be limiting in any way. FIGS. 1-3, for example, show a different type of bearing 10 that is mountable in a wall support.

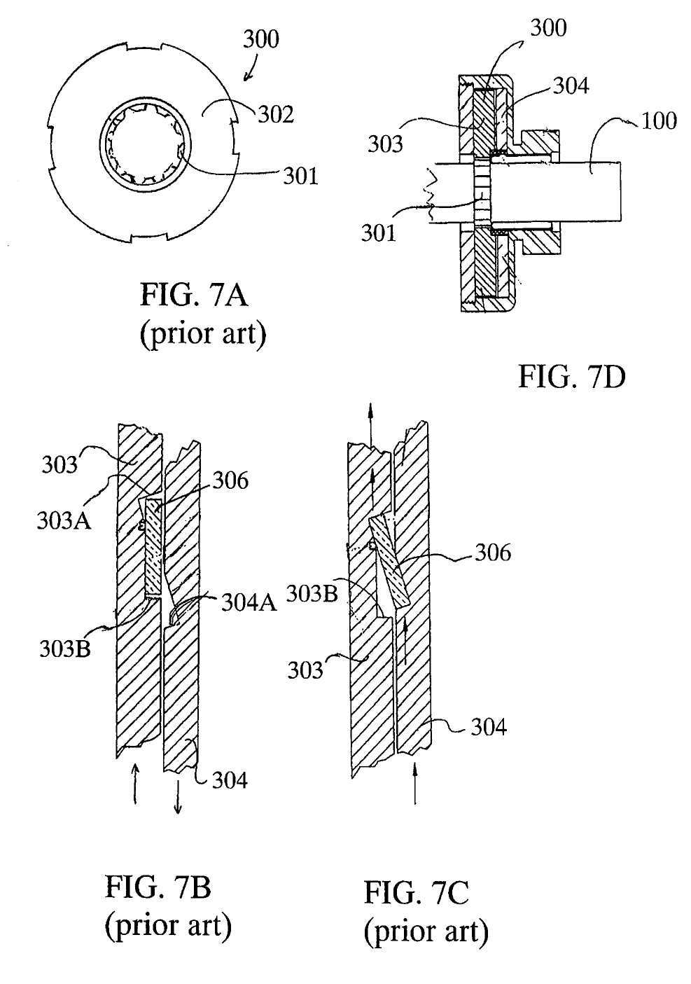

FIGS. 7A-7C illustrate the ORC 300 (prior art). These illustrations are provided only to describe an overrunning clutch that is suitable for use in the MCD 1000 of the present invention and are not intended to limit the scope of protection to the use of this particular overrunning clutch. The ORC 300 has a serrated inner diameter 301 that mates with the input shaft 100, a splined shaft. Encased within an ORC housing 302 are a strut plate 303 and a receptor plate 304. The strut plate 303 has a first strut shoulder 303A and a second strut shoulder 303B; the receptor plate 304 has a receptor shoulder 304A. In overrunning mode, a strut 306 is radially aligned with the strut plate 303. The strut 306 does not engage the receptor pocket 304A as the strut plate 303 rotates past the receptor plate 304, and thus, the rotational motion of the strut plate 303 is not imparted onto the receptor plate 304. When the strut plate 303 is rotated in the opposite direction, however, an end of the spring biased strut 306 snaps into the receptor pocket 304A, effectively and immediately engaging the receptor plate 304, which now rotates with the strut plate 303. FIG. 7D illustrates the ORC 300 mounted on the input shaft 100.

As mentioned above, the intended use for the MCD 1000 is to convert an oscillating input to a continuous rotary output. The MCD 1000, however, could also be used together with a rotary input. In such a configuration, it may not be necessary to use more than a single ORC 300 coupled with one of the bevel gears 210 in the same gear set 200. The MCD 1000 could be used as a gear-reducer, for example, with the two 2:1 output shafts 500 connected to the pinions 220, rotating continuously in opposite directions to each other. The ORC 300 would engage initially and stayed engaged. If two ORC clutches are used, one coupled to each bevel gear 210, the second ORC 300 would continuously operate in overrun mode. If an output shaft 500 is coupled to a bevel gear 210, the shaft will continuously rotate in the direction of its attached bevel gear.

It is understood that the embodiments described herein are merely illustrative of the present invention. Variations in the construction of the mechanical conversion device may be contemplated by one skilled in the art without limiting the intended scope of the invention herein disclosed and as defined by the following claims.

What is claimed is:

1. Mechanical conversion system for transmitting power from an oscillating power input to rotary output, said transmission system comprising:
a gear set comprising two bevel gears and two pinions;
an overrunning clutch coupled with a coupler; and
an input shaft that provides input to said gear set;
wherein said two bevel gears include a first bevel gear and a second bevel gear, each bevel gear having a gear face and each mounted on said input shaft via a bearing for centering and location said bevel gear about said input shaft axis, said gear face of said first bevel gear facing said gear face of said second bevel gear;
wherein said two pinions include a first pinion and a second pinion that are mounted radially to said input shaft, such that said first pinion and said second pinion each mesh with said first bevel gear and said second bevel gear;
wherein said overrunning clutch is mounted on said input shaft and coupled with one of said two bevel gears via said coupler, said overrunning clutch engaging with said input shaft when said input shaft rotates in a first direction, thereby driving said gear set, as long as said input shaft rotates in said first direction at a speed of said gear set.

2. The mechanical conversion system of claim 1, further comprising an output shaft that is coupled to said coupler, said output shaft driven by said gear set to rotate in a continuous, non-oscillatory motion.

3. The mechanical conversion system of claim 2, wherein said output shaft is coupled to one of said bevel gears and rotates at a 1:1 ratio to a rotation of said input shaft.

4. The mechanical conversion system of claim 2, wherein said two pinions have a gear ratio relative to said two bevel gears, and wherein said output shaft is coupled to one of said two pinions to provide an output that rotates at a speed corresponding to said gear ratio.

5. The mechanical conversion system of claim 4, wherein an output shaft is coupled to each of said two pinions, to provide a first pinion shaft output that is rotating in a first direction and a second pinion shaft output that is rotating in a second direction.

6. The mechanical conversion system of claim 1, wherein said overrunning clutch is a one-way non-slip clutch.

7. The mechanical conversion system of claim 6, wherein said overrunning clutch engages in less than 5 degrees of rotation.

8. The mechanical conversion system of claim 1, wherein said input shaft provides input that oscillates between a first direction and a second direction;
wherein said overrunning clutch includes at least two overrunning clutches, a first overrunning clutch coupled with a first coupler and a second overrunning clutch coupled with a second coupler,
wherein said first overrunning clutch is couplable to said first bevel gear with said first coupler and said second overrunning clutch is couplable to said second bevel gear with said second coupler;
wherein, when said input oscillates in said first direction, said first overrunning clutch engages, coupling said input shaft and said first bevel gear, and said second overrunning clutch disengages, uncoupling said input shaft from said second bevel gear, so as to drive said first bevel gear in said first direction with said pinions causing said second bevel gear to rotate in said second direction; and
wherein, when said input oscillates in said second direction, said first overrunning clutch disengages and said second overrunning clutch engages, coupling said input shaft with said second bevel gear, so as to drive said second bevel gear in said second direction, with said two pinions causing said first bevel gear to rotate in said first direction.

9. The mechanical conversion system of claim 8, further comprising an output shaft that is coupled to said gear set and that provides a continuous rotary output.

10. The mechanical conversion system of claim 9, wherein said output shaft is a 1:1 ratio shaft coupled to said second bevel gear.

11. The mechanical conversion system of claim 9, wherein said two pinions have a gear ratio of two revolutions to one revolution of said two bevel gears, and wherein said output shaft is coupled to one of said two pinions to provide a 2:1 output.

12. The mechanical conversion system of claim 11, wherein said output shaft includes a first pinion output and a second pinion output, said first pinion output coupled to a first one and said second pinion output coupled to a second one of said two pinions, wherein said first pinion output rotates in a first pinion direction and said second pinion output rotates in a second pinion direction.
